(19) United States
(12) Patent Application Publication
(10) Pub. No.: US 2020/0198941 A1
(43) Pub. Date: Jun. 25, 2020

(54) Vehicle for the internal transport of heavy-load coils

(71) Applicant: Schaeffler Technologies AG & Co. KG, Herzogenaurach (DE)

(72) Inventors: Thomas Sichert, Gräfenberg (DE); Andreas Willaczek, Hemhofen (DE)

(73) Assignee: Schaeffler Technologies AG & Co. KG, Herzogenaurach (DE)

(21) Appl. No.: 15/753,610

(22) PCT Filed: Jun. 30, 2016
(86) PCT No.: PCT/DE2016/200300

§ 371 Date: Feb. 20, 2018

(30) Foreign Application Priority Data
Sep. 22, 2015 (DE) 10 2015 218 139.1

(51) Int. Cl. B66C 23/36; B66C 23/62; B60P 3/00; B60P 1/54

(52) U.S. Cl. CPC B66C 23/36; B66C 23/62; B60P 3/00; B60Y 2200/416; B60Y 2200/145; B66C 2700/062; B66C 2700/0378; B60P 1/5433

(57) ABSTRACT

Vehicles are disclosed for the internal transport of heavy-load coils. The vehicle may include a drive unit and a loading device coupled thereto. The loading device may be configured to hold a plurality of heavy-load coils. An articulated steering system may be formed between the drive unit and the loading device. The vehicle may include separating elements connected to the loading device, which may be movable parallel to a vehicle longitudinal direction. The separating elements may be configured to secure heavy-load coils of different widths against tilting.

### CROSS-REFERENCE TO RELATED APPLICATIONS

This application is the U.S. National Phase of PCT Appln. No. PCT/DE2016/200300 filed Jun. 30, 2016, which claims priority to DE 102015218139.1 filed Sep. 22, 2015, the entire disclosures of which are incorporated by reference herein.

### TECHNICAL FIELD

The disclosure relates to a vehicle for the internal transport of heavy-load coils, comprising a drive unit and a loading device coupled thereto for holding a plurality of heavy-load coils.

### BACKGROUND

Various possibilities for transporting and handling heavy-load coils are disclosed in the prior art. Thus, the heavy-load coils can be delivered by means of mandrel pilers or transport trucks with stakes or recesses. Furthermore, heavy-load coils are transported by means of indoor portal cranes or pillar jib cranes.

EP 1 202 926 A1 discloses a vehicle for handling heavy-load coils. A bridge-type supporting frame structure provided with wheels, which forms a tunnel, travels over a heavy-load coil lying on the ground, which is aligned with its axis parallel to the ground and perpendicularly to the vehicle longitudinal axis, and can lift and transport the heavy-load coil. The supporting frame structure comprises two longitudinal members arranged spaced apart and a transverse structure which connects the two longitudinal members to one another. An upwardly open section is formed in the tunnel between the two longitudinal members, said section being dimensioned in such a way that the heavy-load coil can be passed through this open section and lifted beyond the height of the tunnel. A lifting device, by means of which heavy-load coils can be gripped and lifted, is furthermore set up on the bridge-type supporting frame structure. An operator's cab and a motor are provided on the vehicle for operating the vehicle.

The disadvantage with the abovementioned prior art is that it is only possible to lift and transport one heavy-load coil at a time with a vehicle of this kind. Moreover, a temporary store, which is designed in such a way that the respective heavy-load coils are freely accessible to the vehicle, is required for the heavy-load coils. This increases the space requirement on site, on the one hand, and increases the time for delivery to the uncoiler, on the other.

### SUMMARY

The object of the disclosure is to develop a vehicle which reduces the delivery steps for heavy-load coils and does not have the abovementioned disadvantages.

According to the disclosure, the vehicle for transporting heavy-load coils has a drive unit and a loading device coupled thereto for holding a plurality of heavy-load coils, wherein an articulated steering system is formed between the drive unit and the loading device. In other words, the axles of the vehicle are not steerable and the drive unit cannot be separated from the loading device during the use of the vehicle, and therefore the steering of the vehicle and the connection of the loading device to the drive unit are accomplished via the articulated steering system.

The vehicle is preferably operated by way of a driver's cab, which is mounted on the drive unit in such a way as to be rotatable about its own axis. As a particular preference, a crane boom, by means of which the heavy-load coils can be lifted and moved, is arranged on the drive unit between the driver's cab and the loading device. In this way, it is possible, on the one hand, for the vehicle to be controlled during travel but, on the other hand, the driver's cab can also be turned through 180° to load the heavy-load coils, and the heavy-load coils can be loaded by means of the crane boom.

The crane boom is preferably mounted rotatably on the drive unit and has a crane jib, which can comprise a plurality of components and is movable in three dimensions. In other words, the components of the crane jib are folded up during travel and extended and moved, preferably hydraulically or electrically, to load the heavy-load coils. As a result, a large radius around the vehicle is reached, wherein heavy-load coils can be reached even in difficult-to-access positions. In particular, this has advantages in respect of the storage of heavy-load coils and likewise facilitates access to the un-coiler.

As a further preference, the vehicle has at least two axles, wherein at least one axle is arranged on the drive unit and on the loading device respectively. If more than one axle is arranged on the drive unit or the loading device, two axles are combined to form a tandem axle in each case. A tandem axle comprises two non-steerable axles arranged a short distance apart symmetrically with respect to the center of gravity of the vehicle. Steering of the vehicle is performed exclusively by means of the articulated steering system between the drive unit and the loading device.

The loading device preferably has a plurality of separating elements for securing the heavy-load coils against tilting. As a particular preference, the separating elements can preferably be moved axially by electric or hydraulic means to enable heavy-load coils of different widths to be transported safely. For this purpose, the separating elements can be either of rod-shaped or of grid-shaped design. In other words, at least one separating element comes to rest against the end face of the respective heavy-load coil to secure it axially against tilting after each heavy-load coil has been loaded. This allows optimum use of the loading device for a plurality of heavy-load coils of different sizes.

As a further preference, the loading device has a rotatable platform to transport the heavy-load coils either in the direction of travel or transversely to the direction of travel. It is thereby possible, in particular, to transport heavy-load coils with a large diameter through narrow passages by rotating the platform.

To secure the heavy-load coils against rolling off at the sides during transport, ramps are preferably arranged on both sides in a respective gap between the heavy-load coil and the loading device.

As a particular preference, the loading device has a frame with a central aperture in which the heavy-load coils are arranged. The advantage of this embodiment is that the heavy-load coils are secured against rolling off perpendicularly to the direction of travel without additional means.

### BRIEF DESCRIPTION OF THE DRAWINGS

Further measures that improve the disclosure are explained in greater detail below together with the description of a preferred illustrative embodiment of the disclosure with reference to the two figures, of which:

FIG. 1 shows a schematic side view of a vehicle according to the disclosure for the internal transport of heavy-load coils, and

FIG. 2 shows a schematic plan view of the vehicle according to the disclosure in accordance with FIG. 1.

### DETAILED DESCRIPTION

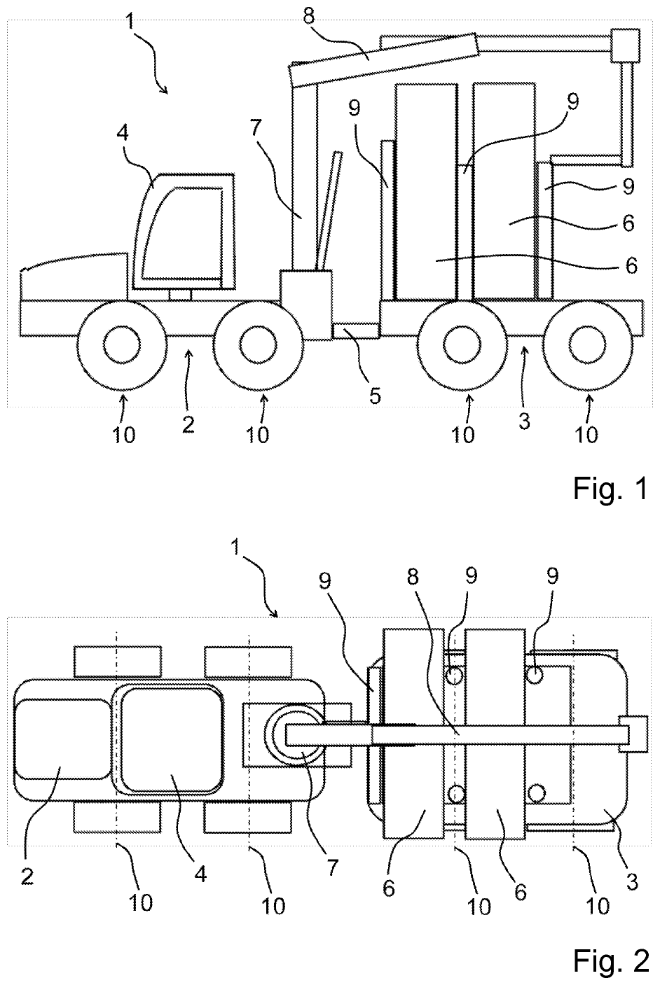

According to FIGS. 1 and 2, the vehicle 1 according to the disclosure for the internal transport of heavy-load coils 6 has a drive unit 2 and a loading device 3 coupled thereto. The loading device 3 is designed to hold heavy-load coils 6, wherein two heavy-load coils are arranged on the loading device 3. The loading device 3 is furthermore coupled to the drive unit 2 by means of an articulated steering system 5. The drive unit 2 has a driver's cab 4, which is mounted on the drive unit 2 in such a way as to be rotatable about its own axis. Moreover, the drive unit 2 has a crane boom 7, which is arranged between the drive unit 2 and the loading device 3 and is mounted so as to be rotatable about its own axis. On the other hand, the crane boom 7 has a crane jib 8, which comprises four components and is movable in three dimensions. The vehicle 1 comprises four axles 10, wherein two axles 10 are formed on the drive unit 2 and two on the loading device 3.

To secure the heavy-load coils 6 against tilting in the vehicle longitudinal direction, rod-shaped separating elements 9 are provided on the loading device 3. The separating elements 9 are movable parallel to the vehicle longitudinal direction in order to secure heavy-load coils 6 of different widths against tilting.

### LIST OF REFERENCE SIGNS

1 vehicle

2 drive unit

3 loading device

4 driver's cab

5 articulated steering system

6 heavy-load coil

7 crane boom

8 boom jib

9 separating element

10 axle

1. A vehicle for the internal transport of heavy-load coils, comprising:
a drive unit and a loading device coupled thereto configured to hold a plurality of heavy-load coils; and
an articulated steering system formed between the drive unit and the loading device.

2. The vehicle as claimed in claim 1, wherein the drive unit has a driver's cab, wherein the driver's cab is mounted on the drive unit in such a way as to be rotatable about its own axis.

3. The vehicle as claimed in claim 2, wherein the drive unit has a crane boom, which is arranged between the driver's cab and the loading device and configured to load the heavy-load coils.

4. The vehicle as claimed in claim 3, wherein the crane boom has a crane jib, wherein the crane boom is mounted in such a way as to be rotatable about its own axis, and the crane jib is movable in three dimensions.

5. The vehicle as claimed in claim 1, wherein the vehicle has at least two axles, wherein at least one axle is arranged on the drive unit and on the loading device, respectively.

6. The vehicle as claimed in claim 1, wherein the loading device has a plurality of separating elements configured to secure the heavy-load coils against tilting.

7. The vehicle as claimed in claim 6, wherein the separating elements are movable parallel to a vehicle longitudinal direction on the loading device.

8. The vehicle as claimed in claim 6, wherein the separating elements are rod-shaped or grid-shaped.

9. A vehicle for the internal transport of heavy-load coils, comprising:
a drive unit and a loading device coupled thereto configured to hold a plurality of heavy-load coils;
an articulated steering system formed between the drive unit and the loading device; and
a plurality of separating elements connected to the loading device and movable parallel to a vehicle longitudinal direction, such that the separating elements are configured to secure heavy-load coils of different widths against tilting.

10. The vehicle as claimed in claim 9, wherein the drive unit has a driver's cab, wherein the driver's cab is mounted on the drive unit in such a way as to be rotatable about its own axis.

11. The vehicle as claimed in claim 10, wherein the drive unit has a crane boom, which is arranged between the driver's cab and the loading device and is configured to load the heavy-load coils.

12. The vehicle as claimed in claim 11, wherein the crane boom has a crane jib, wherein the crane boom is mounted in such a way as to be rotatable about its own axis, and the crane jib is movable in three dimensions.

13. The vehicle as claimed in claim 9, wherein the vehicle has at least two axles, wherein at least one axle is arranged on the drive unit and on the loading device, respectively.

14. The vehicle as claimed in claim 9, wherein the separating elements are rod-shaped or grid-shaped.
